(19) United States
(12) Patent Application Publication
(10) Pub. No.: US 2022/0391434 A1
(43) Pub. Date: Dec. 8, 2022

(54) CENTRALIZED ON-DEVICE IMAGE SEARCH

(71) Applicant: Apple Inc., Cupertino, CA (US)

(72) Inventors: Nicole R. RYAN, San Francisco, CA (US); Nathan DE VRIES, Alameda, CA (US); Michael S. SMOCHKO, San Jose, CA (US); Matias H. SULZBERGER, San Francisco, CA (US); Alexandre R. MOHA, Los Altos, CA (US); Kenneth S. WHITE, San Francisco, CA (US); Lee A. MORGAN, Santa Clara, CA (US)

(21) Appl. No.: 17/574,481

(22) Filed: Jan. 12, 2022

Related U.S. Application Data
(60) Provisional application No. 63/197,226, filed on Jun. 4, 2021.

(51) Int. Cl. G06F 16/583; G06F 16/51; G06V 30/18; G06F 16/532; G06N 5/02

(52) U.S. Cl. CPC G06F 16/583; G06F 16/51; G06V 30/18; G06F 16/532; G06N 5/022

(57) ABSTRACT

A method is provided that includes receiving, from a first application, a first image file and a first set of metadata associated with the first image file, and updating an on-device index based on the first image file and the first set of metadata. The method may further include processing the first image file and the first set of metadata to generate a second set of metadata and updating the on-device index based on the second set of metadata. Upon receiving an image search query the process may identify a plurality of candidate image files from the on-device index based on the image search query, and providing the plurality of candidate image files for display in response to the image search query.

### CROSS-REFERENCE TO RELATED APPLICATION

This application claims the benefit of U.S. Provisional Application No. 63/197,226, filed on Jun. 4, 2021, the entirety of each of which is incorporated herein by reference for all purposes.

### TECHNICAL FIELD

The present description relates generally to image files, including the indexing and searching of image files on an electronic device.

### BACKGROUND

System-wide file searching allows users to search for files based on file name, file type, time of creation, and time of modification. Applications that maintain certain types of files also may maintain descriptive information about those files that goes beyond a file name and timestamp. Different applications also may maintain different descriptive information for the same types of files.

### BRIEF DESCRIPTION OF THE DRAWINGS

Certain features of the subject technology are set forth in the appended claims. However, for purpose of explanation, several embodiments of the subject technology are set forth in the following figures.

FIG. 1 is a block diagram illustrating components of an electronic device in accordance with one or more implementations of the subject technology.

FIG. 2 illustrates an example process for maintaining an on-device index of image files and querying against the on-device index according to aspects of the subject technology.

FIG. 3 illustrates a first result screen of a graphical user interface according to aspects of the subject technology.

FIG. 4 illustrates a second result screen of the graphical user interface according to aspects of the subject technology.

FIG. 5 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Applications maintain different types of information about content or files maintained by the applications. For example, a photo application may perform scene analysis on an image file and store the results of the scene analysis as metadata associated with the image file. Scene analysis may include, but is not limited to, object recognition, facial recognition, saliency analysis, geo location, etc. Other applications may maintain different types of information for image files maintained by those applications. For example, a messaging application may store metadata regarding sender and recipients of an image file, time of receipt, etc.

The subject technology proposes to expand system-wide search functionality to encompass metadata generated and maintained by applications executing on an electronic device as well as system-wide metadata associated with image files. According to aspects of the subject technology, applications may donate image files and/or metadata associated with the image files for inclusion in an on-device index. The image files may be photographs, graphical images, video files, multimedia files, for example. The image files and associated metadata may be processed further from a system-wide perspective to generate additional metadata associated with the image files. Processing may include performing optical character recognition (OCR) on the image files to identify text contained within the images. The on-device index may be updated based on the image files and the associated metadata that was donated with the image files and the additional metadata subsequently generated from a system-wide perspective.

Search queries may be executed against the on-device index to identify image files stored across applications installed on the electronic device. The search results may include image files whose semantic description captured in associated metadata matches some or all of the search query and/or image files containing text that matches some or all of the search query. According to aspects of the subject technology, the top ranked search results across all applications that have donated image files may be provided for display in a first result screen. Upon selection of a user interface affordance, search results may be organized into groups and provided for display as groups in a second result screen. The groups may be based on the application that donated the image files and may separate image files that were matched with the search query based on semantic description or based on text found within the image. Upon selection of another user interface affordance, the application that donated the image files displayed in the search results may be launched and/or brought to the foreground to allow the use to continue searching activities within the application.

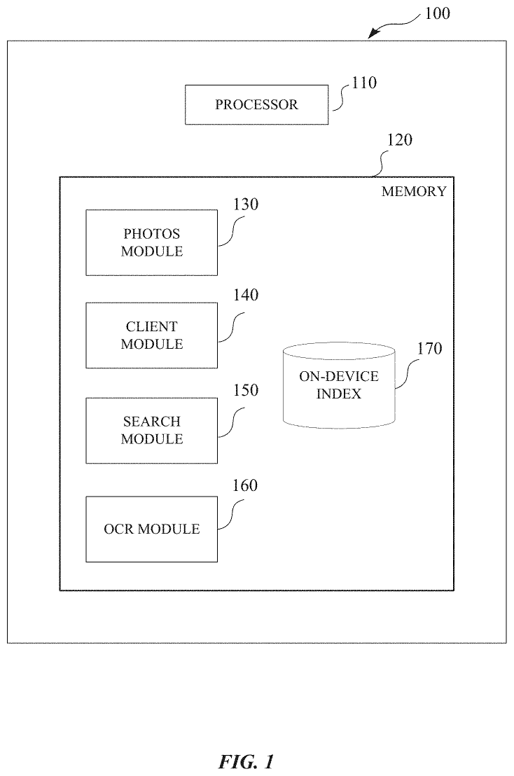

FIG. 1 is a block diagram illustrating components of an electronic device in accordance with one or more implementations of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

In the example depicted in FIG. 1, electronic device 100 includes processor 110 and memory 120. Processor 110 may include suitable logic, circuitry, and/or code that enable processing data and/or controlling operations of electronic device 100. In this regard, processor 110 may be enabled to provide control signals to various other components of electronic device 100. Processor 110 also may control transfers of data between various portions of electronic device 100. Additionally, the processor 110 may enable implementation of an operating system or otherwise execute code to manage operations of electronic device 100.

Processor 110 or one or more portions thereof, may be implemented in software (e.g., instructions, subroutines, code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or may be implemented in a combination of both software and hardware.

Memory 120 may include suitable logic, circuitry, and/or code that enable storage of various types of information such as received data, generated data, code, and/or configuration information. Memory 120 may include, for example, random access memory (RAM), read-only memory (ROM), flash memory, and/or magnetic storage. As depicted in FIG. 1, memory 120 contains photos module 130, client module 140, search module 150, OCR module 160, and on-device index 170. The subject technology is not limited to these components both in number and type, and may be implemented using more components or fewer components than are depicted in FIG. 1.

According to aspects of the subject technology, photos module 130 comprises a computer program having one or more sequences of instructions or code together with associated data and settings. Upon executing the instructions or code, one or more processes are initiated to provide a photos application configured to edit and maintain image files on electronic device 100. The photo application may be configured to perform scene analysis on image files. Scene analysis may include, but is not limited to, object recognition, facial recognition, saliency analysis to identify portions of interest in the image, etc. The scene analysis results may be stored as metadata in association with the corresponding image file.

The photo application may be configured further to supplement metadata associated with an image based on a knowledge graph. The knowledge graph may contain information accessible to the photo application that can be used to further characterize or describe image files. For example, the application's knowledge graph may include data from maps and a calendar application that would facilitate recognizing the context of an image file to identify locations and/or events captured by the image file based on geo location or other information.

According to aspects of the subject technology, client module 140 comprises a computer program having one or more sequences of instructions or code together with associated data and settings. Upon executing the instructions or code, one or more processes are initiated to provide a client application that maintains image files. Client module 140 and the provided client application are intended to represent any client application that maintains image files. For example, the client application may be a messaging application in which image files are sent and received. Similar to the photo application, the messaging application may generate metadata in association with image files that have been sent and/or received. The metadata may include the sender, the recipient(s), time of sending/receipt, etc. Also like the photo application, the messaging application may supplement the metadata based on a knowledge graph containing information accessible to the messaging application. For example, the knowledge graph may include contacts and their associated information as well as frequency and recency of communications with individual contacts.

According to aspects of the subject technology, search module 150 comprises a computer program having one or more sequences of instructions or code together with associated data and settings. Upon executing the instructions or code, one or more processes are initiated to provide search capabilities to a user of electronic device 100. In one or more implementations, the functionality of search module may be divided into two categories. First, search module 150 may be configured to maintain on-device index 170. Second, search module 150 may be configured to execute queries against on-device index 170, rank the results, and provide the results for display on electronic device 100.

The photo application and the client application may be configured to donate image files and associated metadata for inclusion in on-device index 170. Search module 150 may be configured to receive the image files (and/or thumbnails thereof or links thereto) and associated metadata from applications on electronic device 100 and update on-device index 170 based on the image files and associated metadata. Search module 150 may be configured further to supplement the associated metadata by processing the image files and associated metadata based on a knowledge graph containing information accessible to search module 150. This information may include user activity with respect to image files that has been donated as metadata by applications on electronic device 100 in association with those image files. The knowledge graph of search module 150 may allow search module 150 to determine the frequency and recency with which a user of electronic device 100 interacts with contacts across different applications on electronic device 100 and rank those contacts accordingly.

In one or more implementations, search module 150 may provide a universal search box to allow a user to enter a search query for a system-wide search across applications and other content on electronic device 100. Search module 150 may query on-device index 170 with the entered search query and provide candidate image files that are identified in response to the search query for display to the user. In one or more implementations, search module 150 may apply natural language processing to refine the search query entered by the user before querying the on-device index. For example, if the search query was “London photos 2019” the natural language processing may remove “photos” and “2019” from the search query to provide a more scoped search for the main topic of interest “London.” The candidate image files may be organized into sets based on ranking according to relevancy with respect to the search query, based on which application is maintaining the particular candidate image files, based on user activity with respect to the candidate image files, etc. Examples of these different sets are described in more detail below.

According to aspects of the subject technology, OCR module 160 comprises a computer program having one or more sequences of instructions or code together with associated data and settings. Upon executing the instructions or code, one or more processes are initiated to provide optical character recognition processing of image files donated to on-device index 170. Any text recognized in an image file may be added as metadata associated with that image file. OCR module 160 may identify multiple text candidates upon processing an image file. OCR module 160 may keep more than one text candidate (e.g., three) in the metadata as possible matches for the characters found in the image file. While OCR module 160 is described as a separate module in electronic device 100, in one or more implementations, OCR module 160 may be part of photos module 130, client module 140, and/or search module 150.

According to aspects of the subject technology, the data maintained in on-device index 170 remains on electronic device 100 and is not shared with other devices in communication with electronic device 100. Furthermore, in one or more implementations, the data maintained in on-device index 170 is not shared with applications executing on electronic device 100. Accordingly, an application that has donated an image file together with associated metadata is not provided with any supplemental metadata that may be added in association with the image file by search module 150 and/or OCR module 160.

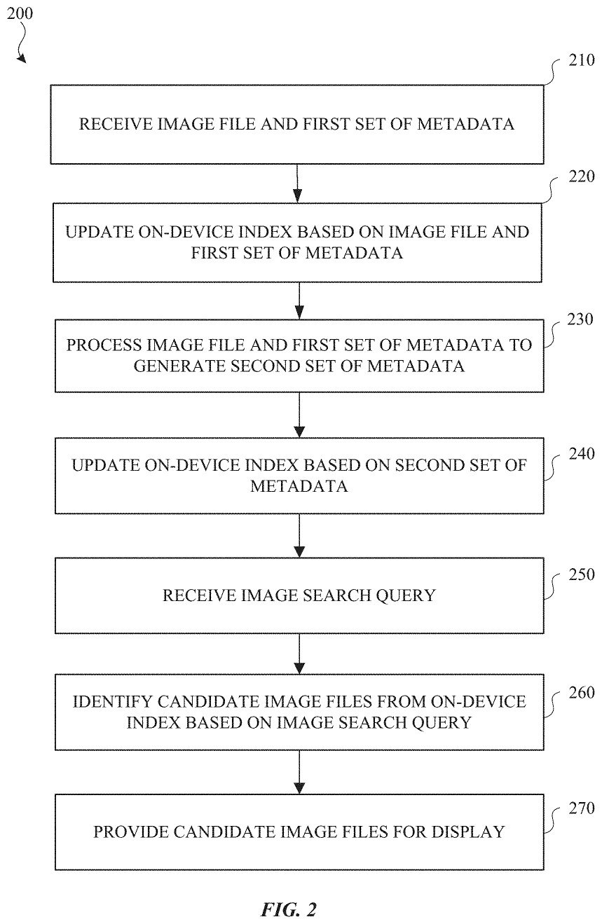

FIG. 2 illustrates an example process for maintaining an on-device index of image files and querying against the on-device index according to aspects of the subject technology. For explanatory purposes, the blocks of the process 200 are described herein as occurring in serial, or linearly. However, multiple blocks of the process 200 may occur in parallel. In addition, the blocks of the process 200 need not be performed in the order shown and/or one or more blocks of the process 200 need not be performed and/or can be replaced by other operations.

Process 200 may be initiated on electronic device when a process executing in search module 150 receives a donation of an image file and associated first set of metadata from one of the applications executing on electronic device 100 (block 210). The process may receive the image file and associated first set of metadata directly or may receive an identifier for the location of the image file and associated first set of metadata. Upon receiving the image file and associated first set of metadata, the process updates an on-device index to include the image file and associated first set of metadata (block 220).

The process in search module 150 continues by processing the image file and associated first set of metadata to generate a second set of metadata associated with the image file (block 230). In one or more implementations, the processing may be done by performing optical character recognition on the image file or by referencing a knowledge graph of user activity across one or more applications with respect to the image file and/or with respect to other users. The process updates the on-device index with the second set of metadata associated with the image file (block 240).

According to aspects of the subject technology, a process executing in search module 150 listens for an image search query to be entered into a universal search box displayed by electronic device 100 (block 250). Upon receipt of the image search query, the process identifies candidate image files from the on-device index by querying the language of the received image search query against the on-device index (block 260).

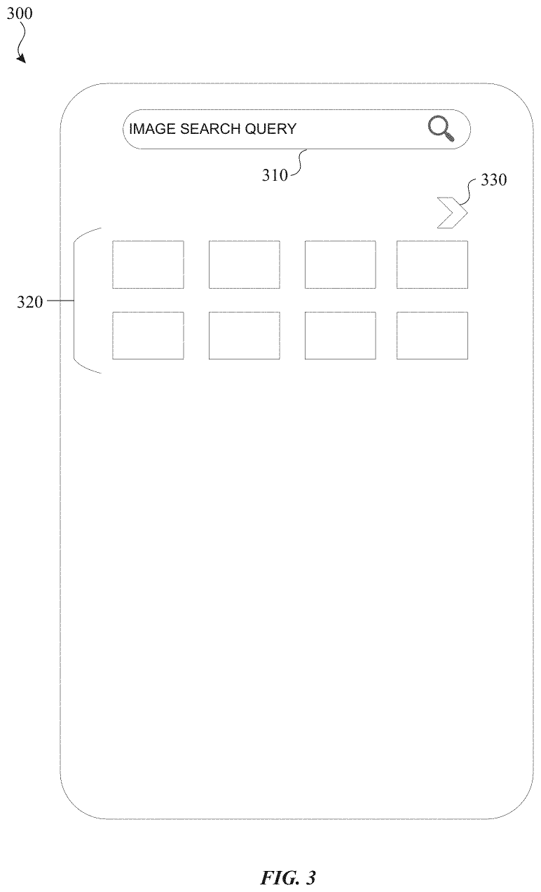

The process in search module 150 may rank and organize the candidate image files before providing them for display by electronic device 100 (block 270). FIG. 3 illustrates a first result screen of a graphical user interface according to aspects of the subject technology. As depicted in FIG. 3, first result screen 300 includes universal search box 310, candidate image files 320, and user interface affordance 330. A user may enter an image search query in universal search box 310, as discussed above. The candidate image files from all applications resulting from querying against the on-device index may be ranked and the top ranked candidate image files 320 displayed in first result screen 300. The candidate image files 320 may be presented as thumbnail images to standardize the appearance for purposes of the result screen. While first result screen 300 illustrates eight candidate image files, the subject technology is not limited to this number of candidate image files presented on first result screen 300. More or fewer than eight candidate image files may be presented in other implementations of the subject technology.

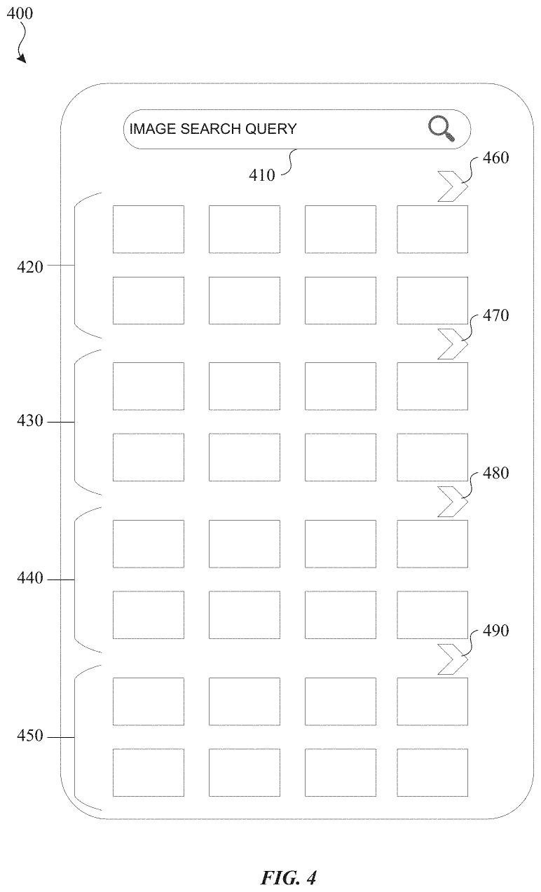

In one or more implementations, user selection of user interface affordance 330 transitions the display of electronic device 100 to a second result screen. FIG. 4 illustrates a second result screen of the graphical user interface according to aspects of the subject technology. As depicted in FIG. 4, second result screen 400 includes universal search box 410, candidate image file groups 420, 430, 440, and 450, and user interface affordances 460, 470, 480 and 490. Similar to the group of candidate image files depicted in FIG. 3, each group in FIG. 4 includes eight candidate image files presented as standardized thumbnail images. The subject technology is not limited to this arrangement and each group may contain more or fewer than eight candidate image files and the images may not be presented in a standardized format.

In one or more implementations, second result screen 400 organizes the candidate image files based on the application that donated the image files to the on-device index. For example, candidate image file group 420 may be a first set of candidate image files that were top ranked from the image search query being executed against the on-device index and were donated by the photo application. Candidate image file group 440 may be a second set of candidate image files that were top ranked from the image search query being executed against the on-device index and were donated by the client application. User selection of user interface affordances 460 or 480 may launch a corresponding application, such as the photo application for affordance 460 or the client application for affordance 480, to continue the searching of image files within the application. The search module may pass the entered image search query into the application's native search process, such as via an application programming interface (API).

In one or more implementations, candidate image file group 430 may be a first set of candidate image files on which optical character recognition was performed and it was determined that the image files contain text matching (exact term match, fuzzy match, etc.) at least partially the image search query and were donated by the photo application. Similarly, candidate image file group 450 may be a second set of candidate image files on which optical character recognition was performed and it was determined that the image files contain text matching at least partially the image search query and were donated by the client application. In both of these sets of candidate image files, the text identified to match at least partially the image search query may be highlighted in the displayed image to draw the user's attention to the recognized text. User selection of user interface affordances 470 or 490 may launch a corresponding application, such as the photo application for affordance 470 or the client application for affordance 490, to continue text recognition searching within the corresponding application if the application has optical character recognition functionality. If the corresponding application does not have this functionality, selection of either affordance 470 or affordance 490 may transition to a result screen showing more candidate image files donated from the corresponding application having at least partial matches to the image search query.

According to aspect of the subject technology, user selection of any of the displayed candidate image files in result screen 300 or result screen 400 may transition to a one-off display of just the selected candidate image file. An additional user interface affordance also may be displayed along with the candidate image file. Selection of the additional user interface affordance may launch the application that donated the candidate image file to the on-device index.

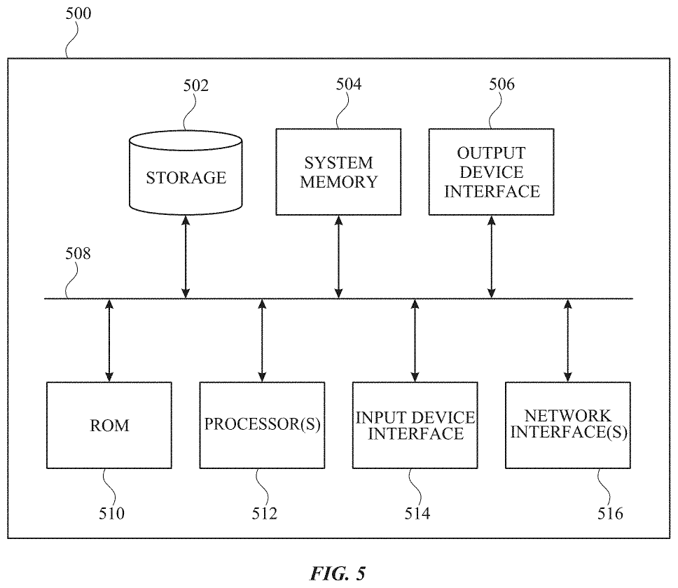

FIG. 5 illustrates an electronic system 500 with which one or more implementations of the subject technology may be implemented. Electronic system 500 can be, and/or can be a part of, electronic device 100 shown in FIG. 1. The electronic system 500 may include various types of computer readable media and interfaces for various other types of computer readable media. The electronic system 500 includes a bus 508, one or more processing unit(s) 512, a system memory 504 (and/or buffer), a ROM 510, a permanent storage device 502, an input device interface 514, an output device interface 506, and one or more network interfaces 516, or subsets and variations thereof.

The bus 508 collectively represents all system, peripheral, and chipset buses that communicatively connect the numerous internal devices of the electronic system 500. In one or more implementations, the bus 508 communicatively connects the one or more processing unit(s) 512 with the ROM 510, the system memory 504, and the permanent storage device 502. From these various memory units, the one or more processing unit(s) 512 retrieves instructions to execute and data to process in order to execute the processes of the subject disclosure. The one or more processing unit(s) 512 can be a single processor or a multi-core processor in different implementations.

The ROM 510 stores static data and instructions that are needed by the one or more processing unit(s) 512 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a floppy disk, flash drive, and its corresponding disk drive) may be used as the permanent storage device 502. Like the permanent storage device 502, the system memory 504 may be a read-and-write memory device. However, unlike the permanent storage device 502, the system memory 504 may be a volatile read-and-write memory, such as random access memory. The system memory 504 may store any of the instructions and data that one or more processing unit(s) 512 may need at runtime. In one or more implementations, the processes of the subject disclosure are stored in the system memory 504, the permanent storage device 502, and/or the ROM 510. From these various memory units, the one or more processing unit(s) 512 retrieves instructions to execute and data to process in order to execute the processes of one or more implementations.

The bus 508 also connects to the input and output device interfaces 514 and 506. The input device interface 514 enables a user to communicate information and select commands to the electronic system 500. Input devices that may be used with the input device interface 514 may include, for example, alphanumeric keyboards and pointing devices (also called “cursor control devices”). The output device interface 506 may enable, for example, the display of images generated by electronic system 500. Output devices that may be used with the output device interface 506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 508 also couples the electronic system 500 to one or more networks and/or to one or more network nodes, such as the content provider 112 shown in FIG. 1, through the one or more network interface(s) 516. In this manner, the electronic system 500 can be a part of a network of computers (such as a LAN, a wide area network (“WAN”), or an Intranet, or a network of networks, such as the Internet. Any or all components of the electronic system 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

In accordance with the subject disclosure, a method is provided that includes receiving, from a first application, a first image file and a first set of metadata associated with the first image file, and updating an on-device index based on the first image file and the first set of metadata. The method may further include processing the first image file and the first set of metadata to generate a second set of metadata and updating the on-device index based on the second set of metadata. Upon receiving an image search query the process may identify a plurality of candidate image files from the on-device index based on the image search query and the on-device index updated based on the first and second sets of metadata, and providing the plurality of candidate image files for display in response to the image search query.

The first set of metadata may be generated by the first application based on a first knowledge graph comprising information accessible to the first application, and the second set of metadata may be generated based on a second knowledge graph, different from the first knowledge graph, comprising system-wide information. The method may further include receiving, from a second application, a second image file and a third set of metadata associated with the second image file, and updating the on-device index based on the second image file and the third set of metadata. The second image file and the third set of metadata may be processed to generate a fourth set of metadata and the on-device index may be updated based on the fourth set of metadata.

The plurality of candidate image files may comprise one or more image files received from the first application and one or more image files received from the second application. The third set of metadata may be generated by the second application based on a third knowledge graph, different from the first and second knowledge graphs, comprising information accessible to the second application.

A first user interface affordance may be provided for display with the plurality of candidate image files in a first result screen. A selection of the first user interface affordance may be received and the plurality of candidate image files may be provided for display in a second result screen, wherein the plurality of candidate image files are organized into a first set corresponding to image files received from the first application and a second set corresponding to image files received from the second application. A second user interface affordance may be provided for display with the first set of the plurality of candidate image files. A selection of the second user interface affordance may be received and the first application may be launched in response to the selection of the second user interface affordance.

Processing the first image file may include performing optical character recognition on the image file. The second set of metadata may comprise results from the optical character recognition. The first set of metadata may comprise optical character recognition processing results generated by the first application. The received image search query may be processed using natural language processing to generate a refined image search query. The plurality of candidate image files may be identified based on the refined image search query.

A non-transitory computer-readable medium may be provided storing instructions which, when executed by one or more processors, cause the one or more processors to perform operations. The operations may include receiving, from a first application, a first image file and a first set of metadata associated with the first image file, wherein the first set of metadata is generated by the first application based on a first knowledge graph comprising information accessible to the first application and updating an on-device index based on the first image file and the first set of metadata. The operations may further include processing the first image file and the first set of metadata to generate a second set of metadata, where the second set of metadata is generated based at least in part on a second knowledge graph, different from the first knowledge graph, and updating the on-device index based on the second set of metadata. Upon receiving an image search query, a plurality of candidate image files may be identified from the on-device index based on the image search query and provided for display in response to the image search query.

The operations may further include providing a first user interface affordance for display with the plurality of candidate image files in a first result screen and receiving a selection of the first user interface affordance. In response to the selection of the first user interface affordance, the plurality of candidate image files may be provided for display in a second result screen. The plurality of image files may be organized into a first set corresponding to image files having scene analysis results at least partially matching the image search query, and a second set corresponding to image files having optical character recognition results at least partially matching the image search query.

Processing the first image file may include performing optical character recognition on the image file, where the second set of metadata comprises results from the optical character recognition. The first set of metadata may include optical character recognition results generated by the first application. The operations may further include providing a second user interface affordance for display with the first set of the plurality of candidate image files, receiving a selection of the second user interface affordance, and launching the first application in response to the selection of the second user interface affordance.

A device may be provided that includes a display, a memory storing a plurality of computer programs and an on-device index, and one or more processors configured to execute instructions of the plurality of computer programs. The instructions may include instructions to receive an image search query, identify a plurality of candidate image files from the on-device index based on the image search query, and display a first set of the plurality of candidate image files in a first result screen on the display in response to the image search query. The instructions may further include instructions to display a first user interface affordance with the plurality of candidate image files in the first result screen on the display, receive a selection of the first user interface affordance, and display, in response to the selection and in a second result screen, a second set of the plurality of candidate images in a first group and a third set of the plurality of images in a second group different from the first group. The second set of the plurality of candidate images may be received from a first application and the third set of the plurality of candidate images may be received from a second application.

The one or more processors may be further configured to execute instructions to display a second user interface affordance with the second set of the plurality of candidate images in the second result screen, receive a selection of the second user interface affordance, and bring the first application to the foreground on the display in response to the selection of the second user interface affordance. The one or more processors may be further configured to execute instructions to display, in the second result screen, a fourth set of the plurality of candidate images in a third group and a fifth set of the plurality of candidate images in a fourth group, where the fourth set of the plurality of candidate images was received from the first application and the fifth set of the plurality of candidate images was received from the second application. Each image in fourth and fifth sets of the plurality of candidate images may contain recognized text comprising at least a portion of the image search query.

The one or more processors may be further configured to execute instructions to receive, from the first application, a first image file and a first set of metadata associated with the first image file, update the on-device index based on the first image file and the first set of metadata, process the first image file and the first set of metadata to generate a second set of metadata, and update the on-device index based on the second set of metadata. The one or more processors may be further configured to execute instructions to receive, from the second application, a second image file and a third set of metadata associated with the second image file, update the on-device index based on the second image file and the third set of metadata, process the second image file and the third set of metadata to generate a fourth set of metadata, and update the on-device index based on the fourth set of metadata. The plurality of candidate image files may comprise one or more image files received from the first application and one or more image files received from the second application.

The collection and transfer of data from an application to other computing devices may occur. The present disclosure contemplates that in some instances, this collected data may include personal information data that uniquely identifies or can be used to identify a specific person. Such personal information data can include demographic data, location-based data, online identifiers, telephone numbers, email addresses, home addresses, images, data or records relating to a user's health or level of fitness (e.g., vital signs measurements, medication information, exercise information), date of birth, or any other personal information.

The present disclosure recognizes that the use of such personal information data, in the present technology, can be used to the benefit of users. Uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of video conferencing, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
receiving, from a first application, a first image file and a first set of metadata associated with the first image file;
updating an on-device index based on the first image file and the first set of metadata;
processing the first image file and the first set of metadata to generate a second set of metadata;
updating the on-device index based on the second set of metadata;
receiving an image search query;
identifying a plurality of candidate image files from the on-device index based on the image search query and the on-device index updated based on the first and second sets of metadata; and
providing the plurality of candidate image files for display in response to the image search query.

2. The method of claim 1, wherein the first set of metadata is generated by the first application based on a first knowledge graph comprising information accessible to the first application, and
wherein the second set of metadata is generated based on a second knowledge graph, different from the first knowledge graph, comprising system-wide information.

3. The method of claim 1, further comprising:
receiving, from a second application, a second image file and a third set of metadata associated with the second image file;
updating the on-device index based on the second image file and the third set of metadata;
processing the second image file and the third set of metadata to generate a fourth set of metadata; and
updating the on-device index based on the fourth set of metadata.

4. The method of claim 3, wherein the plurality of candidate image files comprises one or more image files received from the first application and one or more image files received from the second application.

5. The method of claim 3, wherein the third set of metadata is generated by the second application based on a third knowledge graph, different from the first and second knowledge graphs, comprising information accessible to the second application.

6. The method of claim 3, further comprising:
providing a first user interface affordance for display with the plurality of candidate image files in a first result screen;
receiving a selection of the first user interface affordance; and
providing the plurality of candidate image files for display in a second result screen, wherein the plurality of candidate image files are organized into a first set corresponding to image files received from the first application and a second set corresponding to image files received from the second application.

7. The method of claim 6, further comprising:
providing a second user interface affordance for display with the first set of the plurality of candidate image files;
receiving a selection of the second user interface affordance; and
launching the first application in response to the selection of the second user interface affordance.

8. The method of claim 1, wherein processing the first image file comprises performing optical character recognition on the image file, and
wherein the second set of metadata comprises results from the optical character recognition.

9. The method of claim 1, wherein the first set of metadata comprises optical character recognition processing results generated by the first application.

10. The method of claim 1, processing the received image search query using natural language processing to generate a refined image search query,
wherein the plurality of candidate image files is identified based on the refined image search query.

11. A non-transitory computer-readable medium storing instructions which, when executed by one or more processors, cause the one or more processors to perform operations comprising:
receiving, from a first application, a first image file and a first set of metadata associated with the first image file, wherein the first set of metadata is generated by the first application based on a first knowledge graph comprising information accessible to the first application;
updating an on-device index based on the first image file and the first set of metadata;
processing the first image file and the first set of metadata to generate a second set of metadata, wherein the second set of metadata is generated based at least in part on a second knowledge graph, different from the first knowledge graph;
updating the on-device index based on the second set of metadata;
receiving an image search query;
identifying a plurality of candidate image files from the on-device index based on the image search query and the updated on-device index; and
providing the plurality of candidate image files for display in response to the image search query.

12. The non-transitory computer-readable medium of claim 11, wherein the operations further comprise:
providing a first user interface affordance for display with the plurality of candidate image files in a first result screen;
receiving a selection of the first user interface affordance; and
providing, in response to the selection of the first user interface affordance, the plurality of candidate image files for display in a second result screen,
wherein the plurality of image files are organized into a first set corresponding to image files having scene analysis results at least partially matching the image search query, and a second set corresponding to image files having optical character recognition results at least partially matching the image search query.

13. The non-transitory computer-readable medium of claim 12, wherein processing the first image file comprises performing optical character recognition on the image file, and wherein the second set of metadata comprises results from the optical character recognition.

14. The non-transitory computer-readable medium of claim 12, wherein the first set of metadata comprises optical character recognition results generated by the first application.

15. The non-transitory computer-readable medium of claim 12, wherein the operations further comprise:
providing a second user interface affordance for display with the first set of the plurality of candidate image files;
receiving a selection of the second user interface affordance; and
launching the first application in response to the selection of the second user interface affordance.

16. A device, comprising:
a display
a memory storing:
a plurality of computer programs; and
an on-device index; and
one or more processors configured to execute instructions of the plurality of computer programs to:
receive an image search query;
identify a plurality of candidate image files from the on-device index based on the image search query;
display a first set of the plurality of candidate image files in a first result screen on the display in response to the image search query;
display a first user interface affordance with the plurality of candidate image files in the first result screen on the display;
receive a selection of the first user interface affordance; and
display, in response to the selection and in a second result screen, a second set of the plurality of candidate images in a first group and a third set of the plurality of images in a second group different from the first group,
wherein the second set of the plurality of candidate images was received from a first application and the third set of the plurality of candidate images was received from a second application.

17. The device of claim 16, wherein the one or more processors are further configured to execute instructions to:
display a second user interface affordance with the second set of the plurality of candidate images in the second result screen;
receive a selection of the second user interface affordance; and
bring the first application to the foreground on the display in response to the selection of the second user interface affordance.

18. The device of claim 16, wherein the one or more processors are further configured to execute instructions to:
display, in the second result screen, a fourth set of the plurality of candidate images in a third group and a fifth set of the plurality of candidate images in a fourth group,
wherein the fourth set of the plurality of candidate images was received from the first application and the fifth set of the plurality of candidate images was received from the second application, and
wherein each image in fourth and fifth sets of the plurality of candidate images contains recognized text comprising at least a portion of the image search query.

19. The device of claim 16, wherein the one or more processors are further configured to execute instructions to:
receive, from the first application, a first image file and a first set of metadata associated with the first image file;
update the on-device index based on the first image file and the first set of metadata;
process the first image file and the first set of metadata to generate a second set of metadata;
update the on-device index based on the second set of metadata;
receive, from the second application, a second image file and a third set of metadata associated with the second image file;
update the on-device index based on the second image file and the third set of metadata;
process the second image file and the third set of metadata to generate a fourth set of metadata; and
update the on-device index based on the fourth set of metadata.

20. The device of claim 16, wherein the plurality of candidate image files comprises one or more image files received from the first application and one or more image files received from the second application.
